(19) United States
(12) Patent Application Publication
(10) Pub. No.: US 2012/0042310 A1
(43) Pub. Date: Feb. 16, 2012

(54) METHOD, APPARATUS AND COMPUTER PROGRAM PRODUCT FOR PLATFORM INDEPENDENT FRAMEWORK

(75) Inventors: Rajeswari KANNAN, Bangalore (IN); Ashwin BHAT, Karnataka (IN); Pranav MISHRA, Bangalore (IN); Dharmendra BHOJWANI, Bangalore (IN); Aleksi Filbert KNUUTILA, Tampere (FI)

(73) Assignee: NOKIA CORPORATION, Espoo (FI)

(21) Appl. No.: 13/026,977

(22) Filed: Feb. 14, 2011

(30) Foreign Application Priority Data
Feb. 14, 2010 (IN) 357/CHE/2010

(51) Int. Cl. G06F 9/46; G06F 9/445

(52) U.S. Cl. 717/175; 719/328

(57) ABSTRACT

In accordance with an example embodiment a method and apparatus is provided. The method comprises providing a plurality of plug-ins associated with a platform in a framework, the plurality of plug-ins comprising a set of source plug-ins, a set of target plug-ins and a set of filter plug-ins, the set of filter plug-ins comprising in-built plug-ins and a user-defined plug-ins. A selection of a source plug-in from the set of source plug-ins, at least one filter plug-in from the set of filter plug-ins, and a target plug-in from the set of target plug-ins may be facilitated and the selected source plug-in, the at least one filter plug-in and the target plug-in may be linked for configuring at least one application in the framework.

### CROSS REFERENCE TO RELATED APPLICATION

This application claims the benefit of Indian Provisional Patent Application No. 357/CHE/2010 filed on Feb. 14, 2010, the contents of which are expressly incorporated by reference herein

### TECHNICAL FIELD

Various implementations relate generally to method, apparatus, and computer program product for platform independent framework.

### BACKGROUND

The rapid advancement in technology related to multimedia applications has resulted in an exponential increase in the development of a variety of multimedia applications and/or solutions, such as imaging applications, audio applications, video applications, and the like. Such applications and/or solutions are provided to users by means of various devices such as hand held devices, for example personal digital assistants (PDAs), tablets PCs, and mobile phone; device with converged internet capabilities, such as netbooks and e-book readers; embedded devices; desktops; application store servers; laptops; and the like.

### SUMMARY OF SOME EMBODIMENTS

Various aspects of examples embodiments are set out in the claims.

In a first aspect, there is provided a method comprising: providing a plurality of plug-ins associated with a platform in a framework, the plurality of plug-ins comprising a set of source plug-ins, a set of target plug-ins and a set of filter plug-ins, each filter plug-in of the set of filter plug-ins is one of an in-built plug-in and a user-defined plug-in; facilitating selection of a source plug-in from the set of source plug-ins, at least one filter plug-in from the set of filter plug-ins, and a target plug-in from the set of target plug-ins; and linking the selected source plug-in, the at least one filter plug-in and the target plug-in for configuring at least one application in the framework.

In a second aspect, there is provided an apparatus comprising: at least one processor; and at least one memory comprising computer program code, the at least one memory and the computer program code configured to, with the at least one processor, cause the apparatus at least to: provide a plurality of plug-ins associated with a platform in a framework, the plurality of plug-ins comprising a set of source plug-ins, a set of target plug-ins and a set of filter plug-ins, each filter plug-in of the set of filter plug-ins is one of an in-built plug-in and a user-defined plug-in; facilitate selection of a source plug-in from the set of source plug-ins, at least one filter plug-in from the set of filter plug-ins, and a target plug-in from the set of target plug-ins; and link the selected source plug-in, the at least one filter plug-in and the target plug-in for configuring at least one application in the framework.

In a third aspect, there is provided a computer program product comprising at least one computer-readable storage medium, the computer-readable storage medium comprising a set of instructions, which, when executed by one or more processors, cause an apparatus to at least: provide a plurality of plug-ins associated with a platform in a framework, the plurality of plug-ins comprising a set of source plug-ins, a set of target plug-ins and a set of filter plug-ins, each filter plug-in of the set of filter plug-ins is one of an in-built plug-in and a user-defined plug-in; facilitate selection of a source plug-in from the set of source plug-ins, at least one filter plug-in from the set of filter plug-ins, and a target plug-in from the set of target plug-ins; and link the selected source plug-in, the at least one filter plug-in and the target plug-in for configuring at least one application in the framework.

In a fourth aspect, there is provided a method comprising: providing an editor for facilitating development of a sub-application; providing a plug-in associated with the sub-application to a platform, the platform comprising a plurality of plug-ins, the plurality of plug-ins comprising a set of source plug-ins, a set of target plug-ins and a set of filter plug-ins, each filter plug-in of the set of filter plug-ins is one of an in-built plug-in and a user-defined plug-in, the sub-application plug-in being the user-define plug-in; facilitating selection of a source plug-in from the set of source plug-ins, at least one filter plug-in from the set of filter plug-ins, and a target plug-in from the set of target plug-ins; linking the selected source plug-in, the at least one filter plug-in and the target plug-in for configuring at least one application in the framework; providing a set of binary components for configuring the at least one application; and generating a package to be installed at a target platform based on the set of binary components and configured at least one application.

In a fifth aspect, there is provided a computer program comprising program instructions which when executed by an apparatus, cause the apparatus to: provide a plurality of plug-ins associated with a platform in a framework, the plurality of plug-ins comprising a set of source plug-ins, a set of target plug-ins and a set of filter plug-ins, the set of filter plug-ins comprising in-built plug-ins and user-defined plug-ins; facilitate selection of a source plug-in from the set of source plug-ins, at least one filter plug-in from the set of filter plug-ins, and a target plug-in from the set of target plug-ins; and link the selected source plug-in, the at least one filter plug-in and the target plug-in for configuring at least one application in the framework.

### BRIEF DESCRIPTION OF THE FIGURES

For a more complete understanding of example embodiments of the present invention, reference is now made to the following descriptions taken in connection with the accompanying drawings in which:

FIG. 1 illustrates a device in accordance with an example embodiment;

FIG. 2 illustrates an apparatus for configuring applications platform independent framework in accordance with an example embodiment;

FIGS. 3a, 3b and 3c illustrates example screenshots of display screens for configuring various applications in accordance with an example embodiment;

FIGS. 4a and 4b illustrate example screenshots of display screens for configuring a collage creation application in accordance with an example embodiment;

FIG. 5 is a flowchart depicting an example method for configuring applications in platform independent framework in accordance with an example embodiment; and

FIG. 6 is a flowchart depicting an example method for configuring applications in platform independent framework in accordance with another example embodiment.

### DETAILED DESCRIPTION

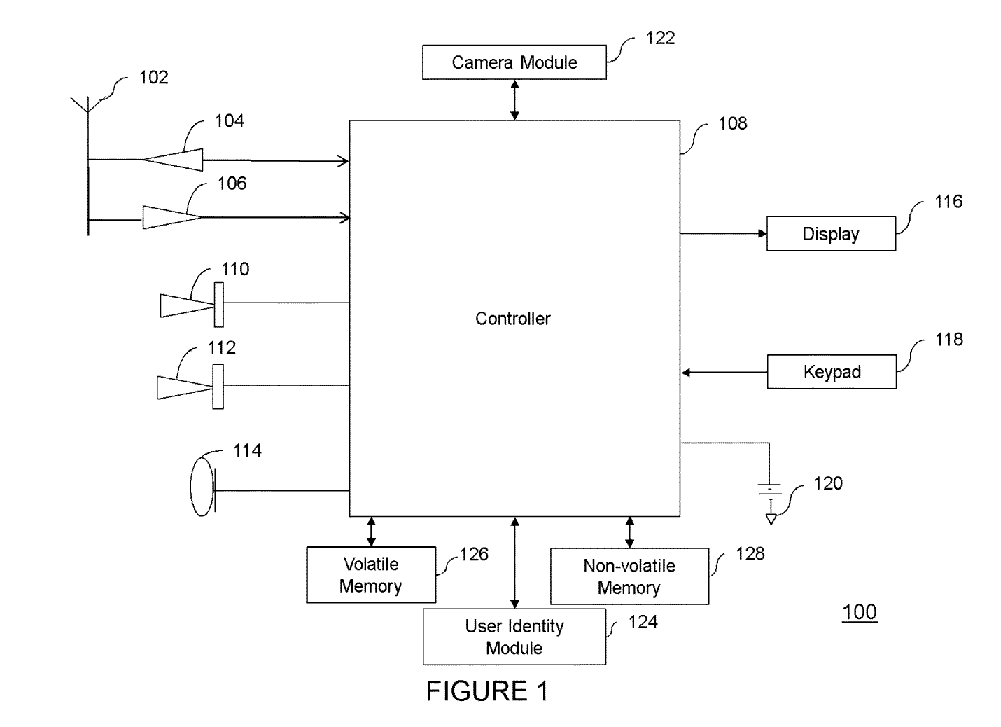

Example embodiments and their potential effects are understood by referring to FIGS. 1 through 6 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of multimedia and/or communication devices.

The device 100 may include an antenna 102 (or multiple antennas) in operable communication with a transmitter 104 and a receiver 106. The device 100 may further include an apparatus, for example, a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, for example Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software necessary for creating a digital image file from a captured image. Alternatively, the camera module 122 may include only the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

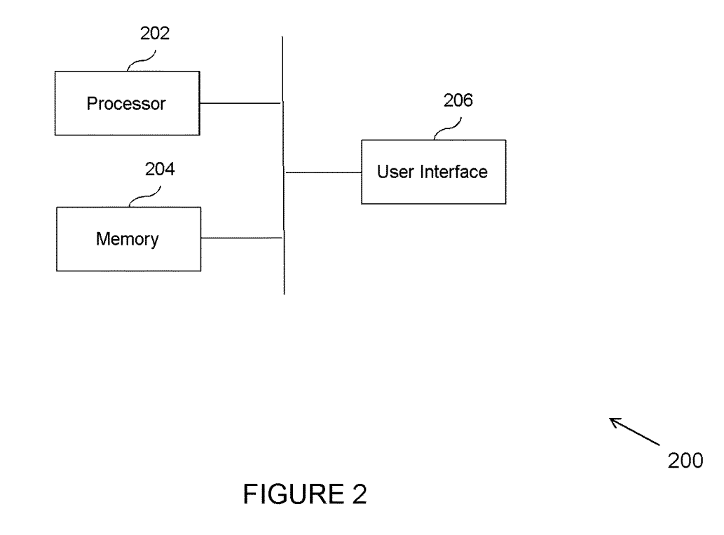

FIG. 2 illustrates an apparatus 200 for configuring applications in a platform independent framework in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. In an example embodiment, the apparatus 200 is a low resource embedded device. In an example embodiment, the apparatus 200 is one of a camera, a mobile phone, a netbook, an e-book reader, a desktop, an application store server and a personal digital assistant (PDA) which may be an example of a communication device. Alternatively or additionally, embodiments may be employed on a combination of devices including, for example, those listed above. Accordingly, various embodiments may be embodied wholly at a single device, (for example, the device 100 or in a combination of devices). It should be noted that some devices or elements described below may not be mandatory and thus some may be omitted in certain embodiments.

In an example embodiment, the apparatus 200 may facilitate configuring one or more applications. The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data, such as audio/video/image files for processing by the processor 202. Additionally or alternatively, the memory 204 may be configured to store instructions for execution by the processor 202. In an example embodiment, the memory 204 is configured to store a plurality of plug-ins, for example a set of source plug-ins, a set of target plug-ins and at least one filter plug-in.

The processor 202, which may be an example of the controller 108 of FIG. 1, may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. Thus, for example, when the processor 202 is embodied as two or more of an ASIC, FPGA or the like, the processor 202 may be specifically configured hardware for conducting the operations described herein. Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface (UI) 206 may be in communication with the processor 202. The UI 206 is configured to receive one or more inputs and provide output to the user. In an example embodiment, the UI 206 includes input interface and an output interface. Examples of the input interface may include, but are not limited to, a keyboard, a mouse, a joystick, a keypad, a touch screen, soft keys, and the like. The output user interface provides an audible, visual, mechanical or other output and/or feedback to the user. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the UI 206, for example, a speaker, ringer, microphone, display, and/or the like.

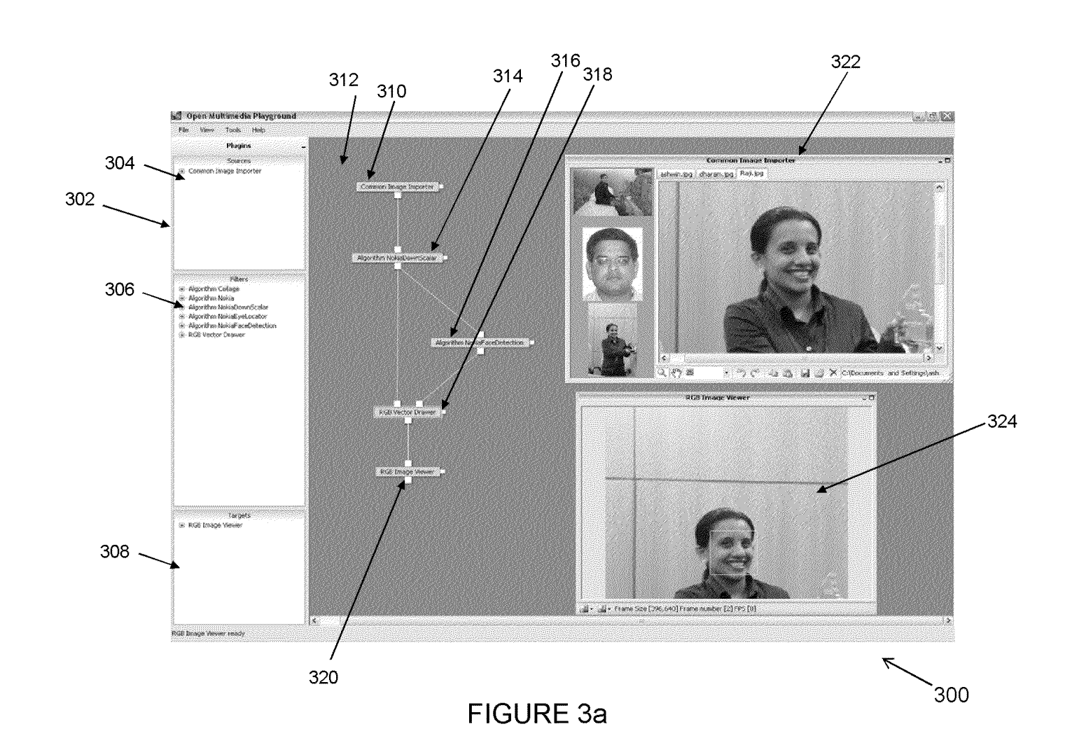

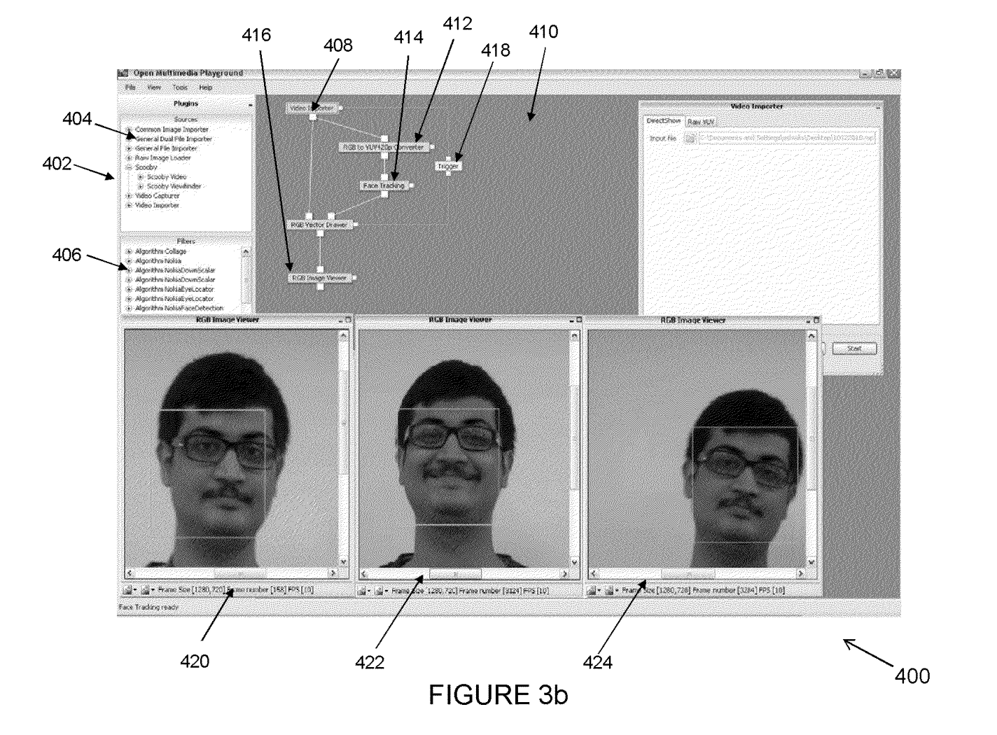

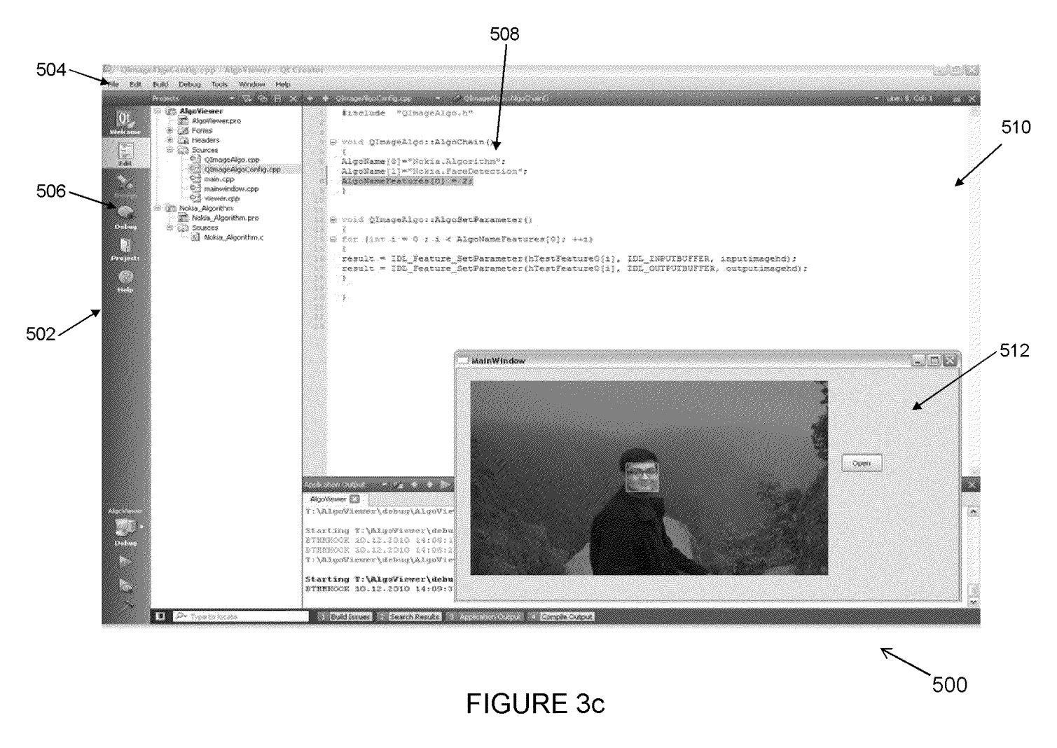

In an example embodiment, the apparatus 200 may include an electronic device. In an example embodiment, the electronic device may be a communication device. In an example embodiment, the communication device may include a mobile phone. In an example embodiment, the communication device may include a user interface, for example, the UI 206, having user interface circuitry and user interface software configured to facilitate a user to control at least one function of the communication device through use of a display and further configured to respond to user inputs. In an example embodiment, the communication device may include a display circuitry configured to display at least a portion of the user interface of the communication device. The display and display circuitry may be configured to facilitate the user to control at least one function of the communication device. For example, the display may include a menu bar. In an example embodiment, the menu bar may extend across a top of the display that may serve to categorize various commands into distinct items available for navigating the UI 206. Clicking on an item on the menu bar may cause a “pull-down” submenu to appear. The submenu may further comprise various items, each of which is associated with a desired action. The UI 206 may also include windows for affording a workspace to the user. The menu bar, the submenu and the windows are described in FIGS. 3a, 3b, and 3c.

In an embodiment, the UI 206 facilitates configuration of applications in the apparatus 200 by means of a platform. Various components for example compiler, linker, debugger, and the like may be associated with the platform for facilitating configuration of applications in the apparatus 200. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

The processor 202 is configured to, with the content of the memory 204, and optionally with other components described herein, to cause the apparatus 200 to provide a plurality of plug-ins associated with a platform in a framework. The plurality of plug-ins includes a set of source plug-ins, a set of target plug-ins and a set of filter plug-ins. Each filter plug-in of the set of filter plug-ins is one of an in-built plug-in and a user-defined plug-in. The plurality of plug-ins may be imaging plug-ins, audio plug-ins, video plug-ins, and plug-in associated with various applications. In an example embodiment, the in-built plug-ins and the user-defined plug-ins may be stored in the internal memory such as hard drive, random access memory (RAM) of the apparatus 200, or retrieved from external storage medium such as digital versatile disk (DVD), compact disk (CD), flash drive, memory card, or from external storage locations through the Internet, Bluetooth®, and the like. The apparatus 200 may also store algorithms corresponding to the plurality of plug-ins in the memory 204. In an example embodiment, a processing means may be configured to provide the plurality of plug-ins associated with the platform in the framework. An example of the processing means may include the processor 202, which may be an example of the controller 108.

In an example embodiment, the plurality of plug-ins associated with the framework may be accessed by utilizing the UI 206. In an example embodiment, the processor 202 is configured to, with the content of the memory 204, and optionally with other components described herein, cause the apparatus 200 to receive user-defined plug-ins for various sub-applications. It will be understood that the user-defined plug-ins may be associated with the sub-applications, and are developed by the user in a UI editor. In an example embodiment, the processor 202 is configured to, with the content of the memory 204, and optionally with other components described herein, cause the apparatus 200 to facilitate development of a user-defined plug-in by a user. As described herein, a plug-in associated with a sub-application may refer to a plug-in that may be linked to one or more associated application plug-ins in order to generate algorithms for developing one or more applications. In an example embodiment, the processor 202 is configured to, with the content of the memory 204, and optionally with other components described herein, cause the apparatus 200 to append the plug-in associated with the sub-application to the existing set of filter plug-ins. For example, a plug-in associated with the sub-application such as a hair stretcher plug-in may be linked to a “face detection application” plug-in to generate an output.

In an example embodiment, the processor 202 is configured to, with the content of the memory 204, and optionally with other components described herein, cause the apparatus 200 to facilitate selection of a source plug-in from the set of source plug-ins, at least one filter plug-in from the set of filter plug-ins, and a target plug-in from the set of target plug-ins for configuring an application. For example, a source plug-in such as a “Common Image Importer” plug-in, a filter plug-in such as an “AlgorithmFaceDetection” plug-in, a target plug-in such as a “RGB Image Viewer” plug-in may be selected for configuring an “RGB image viewer” application. In another example, a source plug-in such as a “Video Importer” plug-in, filter plug-ins such as a “RGB to YUV 420p Converter” and a “Face Tracking” plug-ins, a target plug-in such as an “RGB Image Viewer” plug-in may be selected for configuring an “RGB Image Viewer” application. In an example embodiment, a processing means may be configured to facilitate selection of the source plug-in from the set of source plug-ins, the at least one filter plug-in from the set of filter plug-ins, and the target plug-in from the set of target plug-ins for configuring an application. An example of the processing means may include the processor 202, which may be an example of the controller 108.

In an example embodiment, the source plug-in, the target plug-in, and the at least one filter plug-in are selected automatically by a program and/or by the user. In an example embodiment, the source plug-in, the target plug-in, and the at least one filter plug-in are selected by the user by providing an input using the UI 206. In an example embodiment, the input provided using the UI 206 may be one or multiple mouse-clicks, keyboard keys selection, and the like.

In an example embodiment, the processor 202 is configured to, with the content of the memory 204, and optionally with other components described herein, cause the apparatus 200 to link the selected source plug-in, the at least one filter plug-in and the target plug-in for configuring at least one application in the framework. For example, for configuring the “ROB image Viewer” application utilizing the platform, the source plug-in such as “Common Image Importer” plug-in, the filter plug-in such as “AlgorithmFaceDetection” plug-in, and the target plug-in such as “RGB image Viewer” plug-in may be selected for the purpose of linking. As another example, if a “Face Detection Algorithm” plug-in and a “Downscale Algorithm” plug-in are existing provided, a user can develop other supporting algorithms plug-ins such as nose stretching, hair style changer, face collage algorithm and link these supporting plug-ins to existing plug-ins and produce a desired application. In an example embodiment, the source plug-in, the target plug-in, and the at least one filter plug-in may be selected by one or more of a drag-and-drop operation, double-click operation, a mouse click operation, and other such operations for facilitating the user to easily select the plug-ins for configuring the application. In an example embodiment, a processing means may be configured to link the selected source plug-in, the at least one filter plug-in and the target plug-in for configuring the at least one application in the framework. An example of the processing means may include the processor 202, which may be an example of the controller 108.

In an example embodiment, the plug-ins may be dragged and dropped in an input viewer window in the display screen. In an example embodiment, the plug-ins may include input and output connecting ports such that the user may simply drag and drop the plug-ins to the input window of the display screen of the UI 206, and link the components through these input and output connecting ports. An advantage of providing dragging and dropping option is that the plug-in can be readily and conveniently linked without the need of writing any algorithmic codes for the same, thereby precluding any complexity in configuring the application.

In an example embodiment, the processor 202 may be embodied as to include, or otherwise control, a debugger. The debugger may be any means such as a software or otherwise embodied in hardware or a combination of hardware and software. For example, the processor 202 operating under software control, the processor 202 embodied as an ASIC or FPGA specifically configured to perform the operations described herein, or a combination thereof, thereby configures the hardware to perform the corresponding functions of the debugger. The debugger debugs the code associated with the application to be executed on the platform. In an example embodiment, debugging may be executed by performing an operation, such as a right-click operation of the mouse and allowing a “start” on an associated plug-in such as “Common Importer” component.

In an embodiment, the processor 202 may be embodied as to include, or otherwise control, a code generator. The code generator may be any mean such as a device or circuitry operating in accordance with software or otherwise embodied in hardware or a combination of hardware and software. For example, the processor 202 operating under software control, the processor 202 embodied as an ASIC or FPGA specifically configured to perform the operations described herein, or a combination thereof, thereby configures the apparatus or circuitry to perform the corresponding functions of the code generator. In an example embodiment, the code generator is configured to convert the source code to a readily executable form. In an example embodiment, the code generator facilitates at least in part automatic plugging of a plug-in corresponding to the platform with the framework for configuring the platform with the framework.

In an embodiment, the framework includes a single Application Programming Interface (API) for configuring one or more applications in the framework. In an advantageous mode, a single API may be exposed to the developers for configuring various applications for minimizing the complexity involved in developing the applications since the developer need not learn and remember all the APIs. As the API is implemented, the linking of source plug-in, the filter plug-ins and the target plug-in may be performed at least in part automatically for the required plug-ins. For example, the platform may be called “Playground”, and the command for at least in part automatically linking the plug-ins may be represented in the framework as: “QPlaygoundAlgo (“Name of algorithm”, input buffer, output buffer, . . . ). Accordingly, the algorithms and codecs that reside as part of plug-ins can be dragged and dropped into an Integrated Development Environment (IDE) of the playground.

In an embodiment, the processor 202 is configured to, with the content of the memory 204, and optionally with other components described herein, cause the apparatus 200 to provide wrappers to different platform frameworks. Examples of such platform frameworks include, but are not limited to OpenMax™, GStreamer™, OpenCL™, and the like. In an embodiment, the processor 202 is configured to, with the content of the memory 204, and optionally with other components described herein, cause the apparatus 200 to provide a platform independent layer so that the application developed may be launched on different vendor platform. In an embodiment, the processor 202 is configured to, with the content of the memory 204, and optionally with other components described herein, cause the apparatus 200 to provide at least one binary component for configuring the at least one application. In an example embodiment, the binary components may be provided as plug-ins in the platform. In an example embodiment, a processing means may be configured to provide wrappers to different platform frameworks. An example of the processing means may include the processor 202, which may be an example of the controller 108

FIGS. 3a, 3b and 3c illustrate example screenshots 300, 400, and 500 of display screens for configuring various applications in accordance with an example embodiment Referring to FIG. 3a, a display screen 302 depicting a set of source plug-ins 304, a set of filter plug-ins 306, and a set of target plug-ins 308 linked together for configuring an application, such as a face detection application are shown. In an example embodiment, a source plug-in such as a “Common Image Importer” plug-in 310 may be moved in a window area 312 of the display screen 302. In an example embodiment, the “Common Image Importer” plug-in 310 may be moved by selecting the “Common Image Importer” plug-in 310 from the set of source plug-ins 304. The “Common Image Importer” plug-in 310 may be linked to a “downscaler” plug-in 314 for downscaling the image. A filter plug-in for example an “AlgorithmFaceDetection” plug-in 316 may be linked to the “downscaler” plug-in 314 by dragging the “AlgorithmFaceDetection” plug-in 316 from the set of filter plug-ins 306 and dropping the same into the window area 312. The “downscaler” plug-in 314 may also be directly linked to the “RGB Vector Drawer” plug-in 318. The output connecting port of the “RGB Vector Drawer” plug-in 318 may be linked to an input connecting port of a target plug-in such as an “RGB Image Viewer” plug-in 320. Accordingly, the plug-ins may be linked together for configuring the face detection application.

In an example embodiment, the plug-ins may be linked by dragging and dropping each plug-in from the respective workspaces such as window area 312 on the display screen 302. For example, the source plug-in “Common Image Importer” 310 may be dragged and dropped in the window area 312 from the set of plug-ins 304. In an example embodiment, the plug-ins may include input and output connecting ports for linking the plug-ins. For example, the filter plug-ins may be serially linked with the target plug-ins by connecting the output connecting ports of the filter plug-ins with the input connecting ports of the target plug-in.

In an embodiment, the window area 312 of the display screen 300 may include an input viewer window 322 and an output viewer window 324. The input viewer window 322 is configured to display the content, for example images that may be imported by the source plug-in for example the “Common Image Importer” plug-in 310. The output viewer window 324 is configured to display the output content, for example, face detected by means of “RGB Image Viewer” plug-in 320.

In operation, a user for example a developer may select an input utilizing the “Common Image Importer” plug-in 310. For example, the user may select a set of files in a desired format. In an example embodiment, upon selecting the “Common Image Importer” plug-in 310, the input viewer window 322 is launched. The input viewer window 322 displays the input files to be selected for receiving a desire output. For example, as illustrated in FIG. 3a, the selection of the “Common Inage Importer” plug-in 310 as the source plug-in causes an input viewer window 322 to display all the image files for a desired action such as face detection. The source plug-in “Common Image Importer” plug-in 310 may thereafter be linked with at least one filter plug-in for example an “AlgorithmFaceDetection” plug-in 316. The “Algorithm FaceDetection” plug-in 316 may also include input and output connecting ports. The input port may be directly connected to the source plug-in, for example the “Common Image Importer” plug-in 310 for linking the same. The output connecting ports of the “AlgorithmFaceDetection” plug-in 316 may be directly linked with the input port of the target plug-in “RGB Vector Drawer” plug-in 318, and subsequently with the “RGB image viewer” plug-in 320. In an example embodiment, the filter plug-ins may include various other plug-ins for obtaining desired output.

In an example embodiment, the user-defined plug-in may be appended to the list of the existing set of filter plug-ins. The user-defined filter plug-ins may be developed by a developer. For example, for an existing plug-in such as a face detection and downsclaer plug-ins, a user/developer may develop nose stretching plug-in and/or hair styling plug-in, and/or face collage plug-in. These developed plug-ins may then be linked with the existing plug-ins to produce a desired output. The desired output may be obtained upon linking various plug-ins and executing a code for combining the linked plug-ins. In an example embodiment, the UI 206 may facilitate monitoring of a block (of the linked plug-ins) being executed by assigning distinct colors to the component plug-ins that are being executed. In an example embodiment, the desired output may be viewed in the “output viewer window” 324. As explained in FIG. 2, the code associated with the execution of the block may be debugged by the debugger. In an example embodiment, a visual debugging may be provided under different input conditions. An example of visual debugging is explained in FIG. 3c.

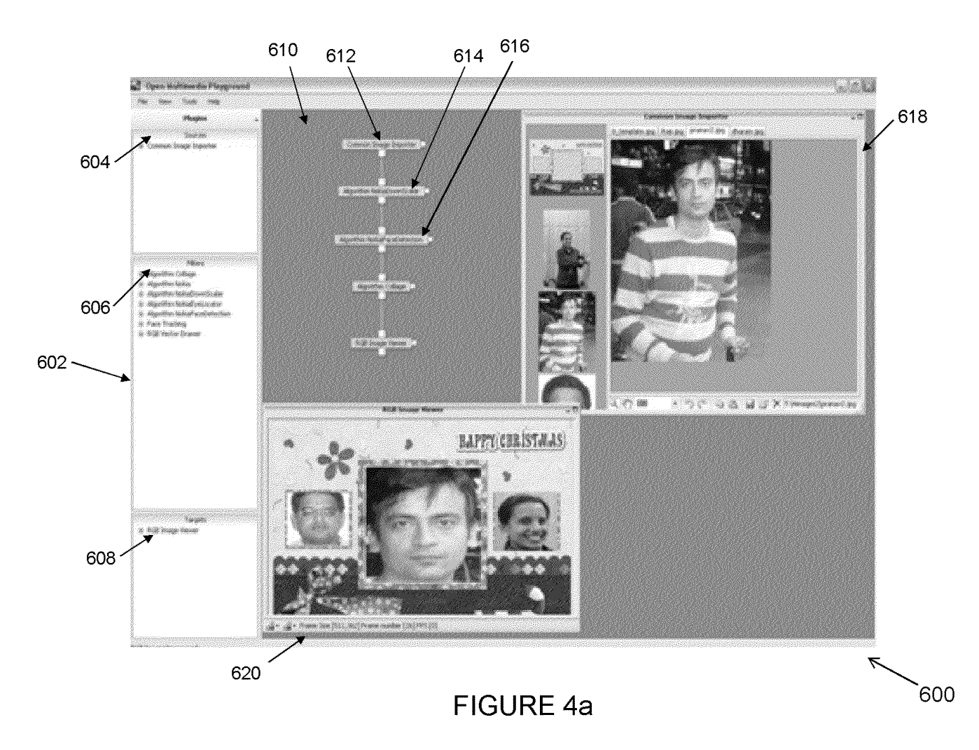

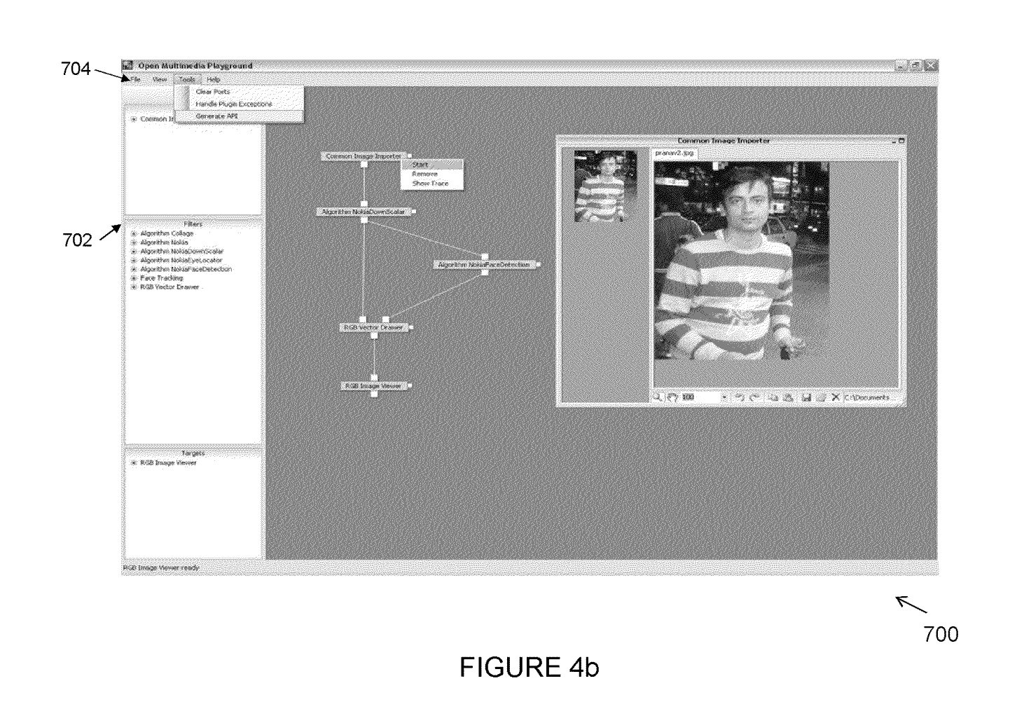

Referring to FIG. 3b, a screenshot 400 of a display screen 402 illustrating video input conditions and display outputs is shown. As illustrated, the display screen 402 depicts a set of source plug-ins 404, a set of filter plug-ins 406, and a set of target plug-ins linked together for configuring an application such as a face detection application. In an example embodiment, a source plug-in for example a “Video Importer” plug-in 408 may be moved in a window area 410. In an example embodiment, the “Video Importer” plug-in 408 may be dragged and dropped from the set of source plug-ins 404 in the window area 410. The “Video Importer” plug-in 408 may be linked to the filter plug-ins such as “RGB to YUV420 Converter” plug-in 412 and “Face Tracking” plug-in 414. A target plug-in such as “RGB Image Viewer” plug-in 416 may be linked with an output connection port of the filter plug-in such as the “Face Tracking” plug-in 418. In an example embodiment, the plug-ins may be linked by dragging and dropping each plug-in from the respective workspaces in the window area 410. In an example embodiment, a “trigger” plug-in 418 may be linked to the source plug-in and the target plug-in for facilitating the trigger of execution code so that the application may be configured. In an example embodiment, the output for different input images may be viewed, for example, an image 420, an image 422, and an image 424. In the example embodiment of FIG. 4, the different input conditions may refer to the different profiles of a face, different place of image capture, and the like.

Referring to FIG. 3c, a screenshot 500 of a display screen 502 for configuring a face detection application is shown. The display screen 502 shows a menu bar 504 illustrating various functions that may be performed on a file such as an image file, an audio file, a video file, and the like. Examples of such functions include, but are not limited to, edit, debug, help, output, project (for listing various projects) and the like. For example, when a “project” tab is activated, a listing of various projects may be popped up. Along with the listing of various projects, a sub-listing of various other algorithms associated with the projects may optionally be shown on the display screen (as marked by 508). The display screen 502 depicts a window area 510 illustrating the code for debugging the algorithm being executed. In an example embodiment, the display screen 502 may include an output viewer window such as a window 512 for displaying the output while the algorithm is debugged.

In another example embodiment, the apparatus 200 may be configured to perform various other applications, such as creating an image collage. The creation of image collage using the disclosed platform is explained with respect to FIGS. 4a and 4b. FIGS. 4a and 4b illustrate example screenshot 600 and screenshot 700 of display screens 602 and display screen 604 respectively, for configuring a collage creation applications in accordance with an example embodiment. Referring to FIG. 4a, a display screen 602 depicts a set of source plug-ins 604, a set of filter plug-ins 606, and a set of target plug-ins 608 that may be linked together for configuring the collage creator application in a window area 610. In an example embodiment, a “face collage creator” plug-in may be developed by a user and appended to the set of filter plug-ins 606. The desired source plug-in, at least one filter plug-in and the target plug-in may be dragged and dropped in a window area 610. As illustrated, a source plug-in “Common Image Importer” 612, “downscaler” plug-in 614 and a “Collage creator” plug-in 616 may be dragged into the window area 610, where these plug-ins may be linked by means of the input and output connecting ports of these plug-ins. For example, a “Face Collage creator” plug-in may be linked to the output of the “AlgorithmFaceDetection” plug-in, as shown in the window area 610 of the display screen 602. Upon linking the plug-ins, an application programming interface (API) may generate a code for configuring the application. In an example embodiment, the display screen 602 may include an input viewer window 618 for displaying the image imported by the “Common Image Importer” plug-in 612; and an output viewer window 620 for displaying the output being generated. Referring to FIG. 4b, the screenshot 700 includes a display screen 702 having a menu bar 704. A function “Generate API” may be selected from the menu bar for generating APIs corresponding to the application to be configured. Upon clicking the “Start” option, a visual debugging of the generated algorithm may be initiated.

In an example embodiment, upon clicking an image using an image capturing device such as a camera, an application such as a collage creator may be launched in the background. A collage of the image along with other images may be presented to the user with a set of faces. In an example embodiment, user defined plug-ins, for example, a plug-in associated with a wrinkle detector algorithm, a hairstyle changer algorithm and a nose stretcher may be linked with the collage creator application. Additionally or optionally, the plug-ins associated with medical imaging algorithms may be linked to the collage generator plug-in for facilitating abnormalities identified in the face.

In an embodiment, any number of plug-ins may be added and linked to the source plug-ins and/or existing filter plug-ins during a capture mode, post-capture mode, at a website, and the like in the framework for configuring an application. The algorithm may be debugged irrespective of the underlying framework and/or architecture.

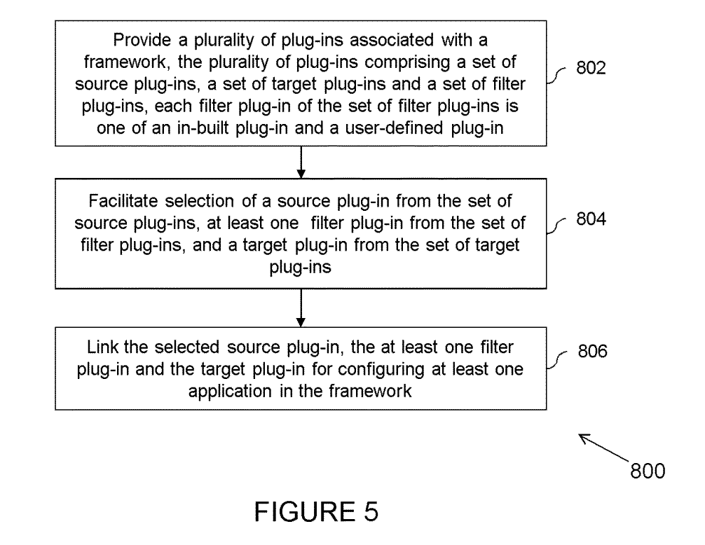

FIG. 5 is a flowchart depicting an example method 800 for configuring applications in accordance with an example embodiment. In an example embodiment, the application may be configured in a media capturing apparatus. In an example embodiment, the application may be configured in one of a mobile phone and a personal digital assistant (PDA)The method 800 depicted in the flow chart may be executed by an apparatus, for example, the apparatus 200 of FIG. 2.

At block 802, a plurality of plug-ins associated with a framework are provided. The plurality of plug-ins includes a set of source plug-ins, a set of target plug-ins and a set of filter plug-ins. Each filter plug-in of the set of filter plug-ins is one of an in-built plug-in and a user-defined plug-in. In an example embodiment, the user-defined plug-in may be developed/programmed by a user such as a developer, and thereafter appended to the set of the filter plug-ins. In an example embodiment, the user-defined plug-in may be appended to the set of existing plug-ins at least in parts automatically.

At block 804, a selection of a source plug-in from the set of source plug-ins, at least one filter plug-in from the set of filter plug-ins, and a target plug-in from the set of target plug-ins is facilitated. In an example embodiment the selection may be performed manually by for example, automated tool/program and/or a user. At block 806, the selected source plug-in, the at least one filter plug-in and the target plug-in may be linked for configuring the at least one application in the framework. In an example embodiment, the source plug-in, the target plug-in, and the at least one filter plug-in may be linked by one of a drag and drop operation, a click operation, and the like. The screenshots displaying linking of the plug-ins are shown in FIGS. 3a, 3b, 3c.

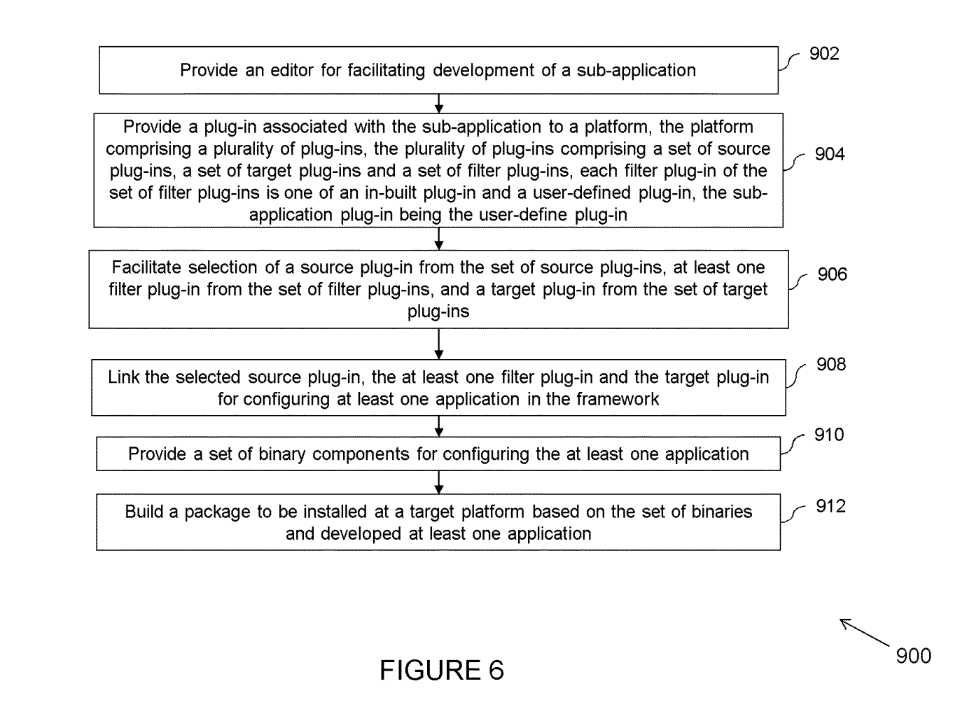

FIG. 6 is a flowchart depicting an example method 900 for configuring applications in accordance with another example embodiment. The method 900 depicted in flow chart may be executed by, for example, the apparatus 200 of FIG. 2. Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 600 are described with help of apparatus 200. However, the operations of the method 600 can be described and/or practiced by using any other apparatus.

A platform independent framework is provided for configuring applications. In an example embodiment, the framework may include an editor that may be configured to develop UI components. At block 902, development of at least one sub-application in the editor may be facilitated. In an example embodiment, the editor may be a UI editor. At block 904, a plug-in associated with the sub-application (hereinafter referred to as sub-application plug-in) is provided. In an embodiment, the sub-application plug-in may be provided to a platform in the framework. In an example embodiment, the platform may be referred to as “Playground”. In an example embodiment, the playground may be installed as a plug-in to UI component for configuring an application. In an example embodiment, the playground may include core functionality components plug-ins, such as algorithms and codecs. In an example embodiment, the component plug-ins may be dragged and dropped into a playground Integrated Development Environment (IDE). In an example embodiment, the playground may provide wrappers to different platform frameworks. Examples of such frameworks include, but are not limited to OpenMax™, GStreamer™, OpenCL™, and the like. In an example embodiment, the playground is configured to provide a platform independent layer so that same application may be launched on different platforms/vendor platforms, thereby facilitating various vendors to write their own proprietary wrappers. Additionally or optionally, playground may facilitate generating of platform specific binary components.

In an embodiment, the playground may include a plurality of plug-ins. The plurality of plug-ins includes a set of source plug-ins, a set of target plug-ins and a set of filter plug-ins. Each filter plug-in of the set of filter plug-ins is one of an in-built plug-in and a user-defined plug-in. As is evident, the sub-application plug-in may be a user-define plug-in.

At block 906, a selection of a source plug-in from the set of source plug-ins, at least one filter plug-in from the set of filter plug-ins, and a target plug-in from the set of target plug-ins is facilitated. In an example embodiment, the selection may be performed by a user.

At block 908, the selected source plug-in, the at least one filter plug-in and the target plug-in are linked for configuring at least one application in the framework. As explained with reference to FIGS. 3a and 3b, and in accordance with an embodiment, the selected plug-ins may be linked by dragging and dropping the selected plug-ins in a window area of a display screen of the UI. In an example embodiment, the plug-ins may include input connecting ports and output connecting ports for linking the plug-ins. Additionally, API may be provided for generation of a source code using the UI. An execution of the generated source code may be performed followed by debugging of the algorithm. The source code may be debugged and at block 910, a set of binary components for configuring the application may be provided. In an example embodiment, the platform facilitates generating of platform specific binary components. At block 912, a package is built that may be installed at a target platform based on the set of binaries and the developed application. It should be noted that some blocks described above may not be mandatory. As such, it should be appreciated that at least some of the blocks described above in connection with the method 900 may be optional and thus in an example embodiment may include more, less or different blocks than those described in connection with the example embodiment of FIG. 6.

Without in any way limiting the scope, interpretation, or application of the claims appearing below, a technical effect of one or more of the example embodiments disclosed herein is to configure applications, for example a face detection application in a platform independent framework. A framework is provided that includes various components for developing applications in a UI editor, and thereafter linking the developed applications with existing plug-ins and codecs in an easy and convenient way, thereby saving time and effort of the user. In an example embodiment, the existing plug-ins may be embodied in a platform, such that the platform may be installable as a plug-in to the UI editor. Also, a single API interface is provided for all the algorithms, thereby precluding the need of learning and remembering many APIs by a developer. An advantage of using the API is that once this API is used, linking of various plug-ins occur at least in parts automatically for required component blocks. The platform also includes wrappers that may be directly used in various other available mobile spaces such as OpenMax™, GStreamer™, and the like. Provision of these wrappers has various advantages since this precluded the developers from bothering about platform specific frameworks, avoids additional adaptation work, vendors can easily provide new solutions as plug-ins to playground and customers can easily do benchmark comparison with multiple vendor plug-ins, and the fragmentation of devices are resolved. Moreover, the framework is a platform independent framework, and accordingly the algorithms once written can work on different platforms with very minimal changes. This greatly enhances time to market for developers who want to push their latest applications to as many platforms as possible in very quick time.

The framework has many advantages, specifically for developers, vendors, and consumers. For example, for the developers the framework provides a development environment integrated with UI IDE and visual debugging. Also, several plug-ins are available for capture, post capture, website and platform side innovation, thereby increasing innovation possibilities. The framework may provide advantageous solutions to the vendors by increasing a developer base, reducing licensing costs and research and development investments due to increased contributions from universities and third party companies and developers, addressing innovation needs on different platforms, reducing the time to market applications, and facilitating evaluation of cross vendor solutions quickly with competition solutions. The consumers may be benefited since the framework provides increased innovative and useful applications.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

What is claimed is:

1. A method comprising:
providing a plurality of plug-ins associated with a platform in a framework, the plurality of plug-ins comprising a set of source plug-ins, a set of target plug-ins and a set of filter plug-ins, the set of filter plug-ins comprising in-built plug-ins and user-defined plug-ins;
facilitating selection of a source plug-in from the set of source plug-ins, at least one filter plug-in from the set of filter plug-ins, and a target plug-in from the set of target plug-ins; and
linking the selected source plug-in, the at least one filter plug-in and the target plug-in for configuring at least one application in the framework.

2. The method of claim 1, wherein the selection of the source plug-in from the set of source plug-ins, the at least one filter plug-in from the set of filter plug-ins, and the target plug-in from the set of target plug-ins is facilitated by a drag-and-drop operation.

3. The method of claim 1 further comprising performing debugging upon linking the selected source plug-in, the at least one filter plug-in, and the target plug-in for configuring the at least one application.

4. The method of claim 1, wherein the framework comprises a single Application Programming Interface (API) for configuring the at least one application in the framework.

5. The method of claim 1, further comprising generating a code for at least partially automatically interfacing the platform to the framework.

6. The method of claim 1 further comprising generating a package comprising with the at least one application, the package configured to be installed on a target platform.

7. An apparatus comprising:
at least one processor; and
at least one memory comprising computer program code, the at least one memory and the computer program code configured to, with the at least one processor, cause the apparatus at least to perform:
providing a plurality of plug-ins associated with a platform in a framework, the plurality of plug-ins comprising a set of source plug-ins, a set of target plug-ins and a set of filter plug-ins, the set of filter plug-ins comprising in-built plug-ins and user-defined plug-ins;
facilitating selection of a source plug-in from the set of source plug-ins, at least one filter plug-in from the set of filter plug-ins, and a target plug-in from the set of target plug-ins; and
linking the selected source plug-in, the at least one filter plug-in and the target plug-in for configuring at least one application in the framework.

8. The apparatus of claim 7, wherein the apparatus is further caused, at least in part, to perform: selecting the source plug-in from the set of source plug-ins, the at least one filter plug-in from the set of filter plug-ins, and the target plug-in from the set of target plug-ins is facilitated by a drag-and-drop operation.

9. The apparatus of claim 7, wherein the apparatus is further caused, at least in part, to perform: debugging upon linking the selected source plug-in, the at least one filter plug-in, and the target plug-in for configuring the at least one application.

10. The apparatus of claim 7, wherein the framework comprises a single Application Programming Interface (API) for configuring the at least one application in the framework.

11. The apparatus of claim 7, wherein the apparatus is further caused, at least in part, to perform: generating a code for at least partially automatically interfacing the platform to the framework.

12. The apparatus of claim 7, wherein the platform comprises a plurality of wrappers for rendering a platform-independent functionality to the at least one application.

13. The apparatus of claim 7, wherein the platform comprises at least one binary component for configuring the at least one application.

14. The apparatus of claim 7, wherein the apparatus is further caused, at least in part, to perform: generating a package comprising with the at least one application, the package configured to be installed on a target platform.

15. The apparatus of claim 7, wherein the apparatus comprises a communication device comprising:
a user interface circuitry and user interface software configured to facilitate a user to control at least one function of the communication device through use of a display and further configured to respond to user inputs; and
a display circuitry configured to display at least a portion of a user interface of the communication device, the display and display circuitry configured to facilitate the user to control at least one function of the communication device.

16. The apparatus of claim 15, wherein the communication device comprises a mobile phone.

17. A computer program product comprising at least one computer-readable storage medium, the computer-readable storage medium comprising a set of instructions, which, when executed by one or more processors, cause an apparatus to at least:
provide a plurality of plug-ins associated with a platform in a framework, the plurality of plug-ins comprising a set of source plug-ins, a set of target plug-ins and a set of filter plug-ins, the set of filter plug-ins comprising in-built plug-ins and user-defined plug-ins;
facilitate selection of a source plug-in from the set of source plug-ins, at least one filter plug-in from the set of filter plug-ins, and a target plug-in from the set of target plug-ins; and
link the selected source plug-in, the at least one filter plug-in and the target plug-in for configuring at least one application in the framework.

18. The computer program product of claim 17, wherein the apparatus is further caused, at least in part, to select the source plug-in from the set of source plug-ins, the at least one filter plug-in from the set of filter plug-ins, and the target plug-in from the set of target plug-ins is facilitated by a drag-and-drop operation.

19. The computer program product of claim 17, wherein the apparatus is further caused, at least in part, to perform debugging upon linking the selected source plug-in, the at least one filter plug-in, and the target plug-in for configuring the at least one application.

20. The computer program product of claim 17, the framework comprises a single Application Programming Interface (API) for configuring the at least one application in the framework.

21. The computer program product of claim 17, wherein the apparatus is further caused, at least in part, to generate a code for at least partially automatically interfacing the platform to the framework.

22. The computer program product of claim 17, wherein the apparatus is further caused, at least in part, to generate a package comprising with the at least one application, the package configured to be installed on a target platform.

23. A method comprising:
providing an editor for facilitating development of a sub-application;
providing a plug-in associated with the sub-application to a platform, the platform comprising a plurality of plug-ins, the plurality of plug-ins comprising a set of source plug-ins, a set of target plug-ins and a set of filter plug-ins, the set of filter plug-ins comprising in-built plug-ins and user-defined plug-ins, the sub-application plug-in being a user-define plug-in;
facilitating selection of a source plug-in from the set of source plug-ins, at least one filter plug-in from the set of filter plug-ins, and a target plug-in from the set of target plug-ins;
linking the selected source plug-in, the at least one filter plug-in and the target plug-in for configuring at least one application in the framework;
providing a set of binary components for configuring the at least one application; and
generating a package to be installed at a target platform based on the set of binary components and the configured at least one application.

24. A computer program comprising program instructions which when executed by an apparatus, cause the apparatus to:
provide a plurality of plug-ins associated with a platform in a framework, the plurality of plug-ins comprising a set of source plug-ins, a set of target plug-ins and a set of filter plug-ins, the set of filter plug-ins comprising in-built plug-ins and user-defined plug-ins;
facilitate selection of a source plug-in from the set of source plug-ins, at least one filter plug-in from the set of filter plug-ins, and a target plug-in from the set of target plug-ins; and
link the selected source plug-in, the at least one filter plug-in and the target plug-in for configuring at least one application in the framework.
